(19) United States
(12) Patent Application Publication
(10) Pub. No.: US 2009/0214969 A1
(43) Pub. Date: Aug. 27, 2009

(54) PROTECTIVE OVERCOAT OF PHOTORECEPTOR HAVING A CHARGE TRANSPORT COMPOUND

(75) Inventors: Jennifer A. COGGAN, Cambridge (CA); Nan-Xing HU, Oakville (CA); Matthew A. HEUFT, Oakville (CA); Kathy L. DE JONG, London (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 12/037,567

(22) Filed: Feb. 26, 2008

(51) Int. Cl. G03C 1/73; G03G 15/02; G03G 15/30

(52) U.S. Cl. 430/58.75; 430/72; 430/58.65; 399/149

(57) ABSTRACT

A photoconductive member a layer including a substantially crosslinked product of a film-forming composition having at least a curing agent and a charge transport compound, wherein the charge transport compound has at least one group imparting charge transporting functionality, at least one crosslinking group and at least one fluorene moiety.

### BACKGROUND

Described herein is a layered member, and more specifically a photoconductive member, that comprises an overcoat layer that includes a cured or substantially crosslinked product of at least a curing agent, optionally polymer binder and/or co-binder, and a charge transport compound, such as a fluorene moeity containing charge transport compound.

The photoconductive members described herein may be used in, for example, electrophotographic imaging devices and xerographic imaging devices, printing processes, color imaging processes, copying/printing/scanning/fax combination systems and the like. The photoconductive member may have any suitable form, for example plate, endless belt or drum form.

Photosensitive members such as electrophotographic or photoconductive members, including photoreceptors or photoconductors, typically include a photoconductive layer formed on, for example, an electrically conductive substrate or formed on layers between the substrate and photoconductive layer. The photoconductive layer is an insulator in the dark, so that electric charges are retained on its surface. Upon exposure to light, the charge is dissipated, and an image can be formed thereon, developed using a developer material, transferred to a copy substrate, and fused thereto to form a copy or print.

Advanced imaging systems are based on the use of small diameter photoreceptor drums. The use of small diameter drums places a premium on photoreceptor life. A factor that can limit photoreceptor life is wear. Small diameter drum photoreceptors are particularly susceptible to wear because about 3 to 10 revolutions of the drum may be required to image a single letter size page. Multiple revolutions of a small diameter drum photoreceptor to reproduce a single letter size page can thus require about 1 million cycles or more from the photoreceptor drum to obtain 100,000 prints, one desirable print job goal for commercial systems.

### REFERENCES

Various polymeric overcoats to provide crack, scratch and abrasion resistance have been proposed for photoreceptors. These various polymeric overcoats have provided improvements in crack, abrasion and scratch resistance in overcoats for photoreceptors. The various polymeric overcoats have a design that includes crosslinking sites to provide improved crack, abrasion and scratch resistance. However, in these overcoats, a hole transporting function is located within the same portion of the compound as the crosslinking sites.

Disclosed in U.S. patent application Ser. No. 11/459,827, incorporated herein by reference in its entirety, is a photoconductive member comprising a substrate, a charge generating layer, a charge transport layer and a polymeric overcoat layer that includes a cured or substantially crosslinked product of at least a melamine-formaldehyde resin and a charge transport compound, and an optional phenol compound. The polymeric overcoat layer is applied to the surface of the charge transport layer of the photoconductive to provide a protective layer to prevent damage from cracking, scratching and abrasion and to prolong the service life of the photoconductive member.

Many current photoreceptor systems utilize either DHTBD or DHMTPA as the hole transporting material or charge transport compound of the polymeric overcoat layer. These current hole transporting materials have the following molecular structures:

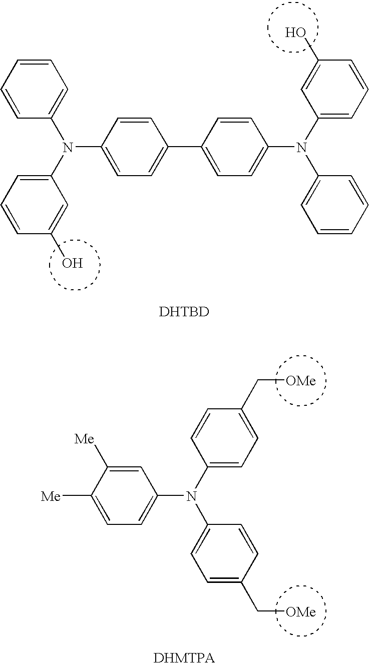

Each molecule of DHTBD and/or DHMTPA includes crosslinking sites (circled) directly attached to triarylamine or hexaryldiamine units, which are the groups imparting charge transporting functionality to the molecule.

Alterations to the above molecules may thus adversely affect the charge transporting and/or the crosslinking properties of the compounds. Thus, attempts to alter the molecular structure of DHTBD or DHMTPA in an effort to improve the crosslinking density and thus the durability of the layer, may result in problems with crosslinking the charge transport capability of the molecule, or both.

While current photoreceptor polymeric overcoats including DHTBD and DHMTPA are acceptable for their intended purposes with the disclosed photoconductive member having a charge generating layer and a charge transport layer, it is still desired to provide photoconductive members having an overcoat layer with improved abrasion, scratch and crack resistance. Such improved overcoat layers may overcome the above and other problems to provide a new class of hole transporting materials or charge transporting compounds. The improved overcoat layer herein includes a charge transporting compound having a molecular structure that separates the two functionalities of the molecule, namely the crosslinking sites of the molecule and the charge transporting functionality, for example arylamine, of the molecule.

### SUMMARY

In embodiments, disclosed is a photoconductive member having a layer comprising a substantially crosslinked product of a film-forming composition comprised of at least a curing agent and a charge transport compound, wherein the charge transport compound has at least one group imparting charge transporting functionality, at least one crosslinking group and at least one fluorene moiety.

Also disclosed is an image forming apparatus having at least one charging unit, at least one exposing unit, at least one developing unit, a transfer unit, a cleaning unit, and a photoconductive member that is in association with each unit or passes by each unit, comprising a layer comprising a substantially crosslinked product of a film-forming composition comprised of at least a curing agent and a charge transport compound, wherein the charge transport compound has at least one group imparting charge transporting functionality, at least one crosslinking group and at least one fluorene moiety.

### EMBODIMENTS

The present disclosure relates generally to photoconductive members such as photoconductors, photoreceptors and the like, for example which may be used in electrophotographic or xerographic imaging processes. The photoconductive members herein include a layer, such as an overcoat layer, that may achieve adhesion to other layers of the photoconductive members, such as, for example, a charge transport layer, and exhibits excellent coating quality. Thus, the resulting imaging member achieves excellent image quality and mechanical robustness. The protective overcoat layer may increase the extrinsic life of a photoconductive member and may maintain good print quality, ghosting resistance, deletion resistance and/or easy scalability when used in an image forming apparatus.

The overcoat layer comprises the cured, or substantially crosslinked, product of at least a curing agent and a hole transporting material (hereinafter “the charge transport compound”). The overcoat layer may further comprise an optional polymer binder and/or co-binder and/or an acid catalyst.

“Cured” herein refers to, for example, a state in which the curing agent and optionally polymer binder and/or co-binder in the overcoat coating solution have reacted with each other and/or the charge transport compound to form a crosslinked or substantially crosslinked product. “Substantially crosslinked” in embodiments refers to, for example, a state in which about 60% to 100% of the charge transport compounds in the overcoat composition, for example about 70% to 100% or about 80% to 100%, are covalently bound in the composition. The overcoat layer may cure by crosslinking or substantially crosslinking the curing agent, the optional polymer binder and/or co-binder and the charge transport compound.

The curing or crosslinking of the reactive components occurs, in embodiments, following application of the overcoat coating composition to any previously formed structure of the imaging member. The overcoat coating composition thus comprises at least the curing agent and the charge transport compound, and optionally one or more polymer binders.

The charge transport compound of the overcoat layer includes at least one group imparting charge transporting functionality and at least one crosslinking group, wherein the at least one group imparting charge transporting functionality is not directly linked to the at least one crosslinking group. In embodiments, this is achieved with a charge transport compound including at least one fluorene moiety to which is attached, at different portions of the fluorine moiety, the at least one group imparting charge transporting functionality and the at least one crosslinking group.

Fluorene has the following molecular structure:

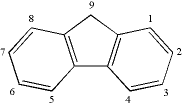

In embodiments, the fluorene moiety may be fluorene or a fluorene derivative, Fluorene derivatives have the above core structure, with different groups linked to the core structure, that is, linked at the 1-9 positions of the fluorine structure, or with heteroatom substitution at one or more of the 1-9 position carbon atoms.

In embodiments, the at least one crosslinking groups are desirably linked at the 9-position of the fluorene moiety.

For example, in embodiments, suitable examples of fluorene derivatives may include any one of the following compounds:

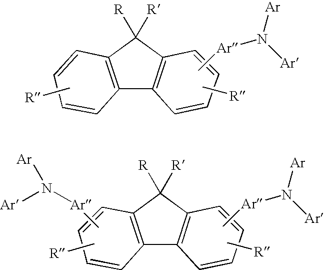

and mixtures thereof, wherein R, R′ and R″ may be the same or different, and wherein at least one of R, R′ and R″ represents a crosslinking group, and wherein Ar, Ar′ and Ar″ each may independently represent an aryl or arylene group in the arylamine structure making up the group imparting charge transporting functionality to the charge transport compound.

Thus, in the above formulas, one or more of R, R′ or R″ may be the crosslinking group. At least one of R, R′ and R″ must represent a crosslinking group. For example, if R and/or R′ represent H (a non-crosslink group), R″ in the compound must represent a crosslinking group. “Crosslinking group” herein refers to a group including in its structure at least one crosslinking site. The crosslinking group may in its simplest form be the crosslinking site, as with an OH group. Alternatively, the crosslinking group may comprise the crosslinking site linked to a molecule or chain linking the crosslinking site with the charge transport compound. In embodiments, the one or more crosslinking groups of the charge transport compound comprise, for example, OH or groups including one or more OH groups, desirably one or more OH group(s) at the end of a molecule or chain so as to be available for crosslinking. The OH group(s) provide the crosslinking site(s) for the charge transport compound. Suitable examples of crosslinking groups include, for example, OH, hydroxy-substituted alkyl groups wherein the alkyl group may have from 1 to about 32, such as from 1 to about 8, carbon atoms, hydroxy-substituted alkoxyl groups, wherein the alkoxyl group may have from 1 to about 32, such as from 1 to about 8, carbon atoms, a hydroxy-substituted aryl group, including wherein the aryl group is phenyl, benzyl, tolyl, xylyl and the like, a hydroxy-substituted aralkyl group, wherein “aralkyl” refers to an aryl alkyl, or alkyl substituted with an aryl, wherein the alkyl group and aryl group have the size described above, and the like. An alkyl group and/or an alkoxyl group refers to a functional group that is linear, branched, saturated, unsaturated, substituted, or unsubstituted. An aryl group refers to a functional group, such as a phenyl ring group, having a formula of C₆H₅ where six carbon atoms are arranged in a cyclic ring structure, and may be substituted or unsubstituted with groups other than hydroxy. Other substitutions may be selected from, for example, silyl groups, nitro groups, cyano groups, amine groups, alkoxy groups, aryloxy groups, alkylthio groups, arylthio groups, aldehyde groups, ketone groups, ester groups, amide groups, carboxylic acid groups, sulfonic acid groups, and mixtures thereof.

When the crosslinking group is attached at the 9-position of a fluorene moiety, that is, the crosslinking group is R or R′ in the above formulas, the crosslinking group desirably is OH, a hydroxy-substituted alkyl group wherein the alkyl group may have from 1 to about 8 carbon atoms, a hydroxy-substituted alkoxyl group, wherein the alkoxyl group may have from 1 to about 8 carbon atoms, a hydroxy-substituted aryl group, a hydroxy-substituted aralkyl group, wherein the alkyl group and aryl group are as described above, and the like.

When R, R′ or R″ is not a crosslinking group, it may be any group without limitation, including H, an alkyl group, an alkoxyl group, an aryl group, an aryl alkyl group, and the like.

The crosslinking site(s) are not directly linked to a group imparting the charge transporting functionality, such as an arylamine group, unlike in the structures for DHTBD and DHMTPA. In this regard, a linking group such as an alkyl, alkoxyl, aryl, aryl alkyl and the like in the crosslinking group may act to separate the crosslinking site(s) of the charge transport compound from a group imparting charge transporting functionality, while at the same time linking the two components, that is, linking the crosslinking site(s) of the compound to a group imparting charge transporting functionality to the compound.

The at least one group imparting a charge transporting functionality refers to the group linked to the compound to impart the necessary charge transporting properties to the compound. While the fluorene or other moiety may also contribute to and/or exhibit charge transporting functionality, the group imparting a charge transporting functionality refers to the group added to the fluorene or other moiety to impart the necessary charge transporting function to the molecule.

In embodiments, the group imparting charge transporting functionality to the compound, which may also be referred to as the charge transporting group, is an arylamine. Again, example fluorene moiety compounds herein may have the formulas:

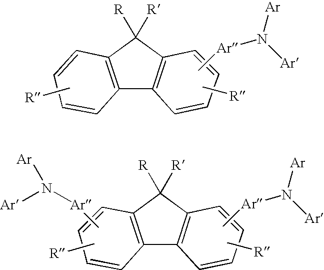

wherein the N—Ar—Ar′—Ar″ group is an arylamine, such as a triarylamine. In this regard, Ar, Ar′ and Ar″ each may independently represent a substituted or unsubstituted aryl group, as defined above, or Ar″ may independently represent a chemical bond between the nitrogen atom and the fluorene moiety, or a substituted or unsubstituted arylene group. Ar, Ar′ and/or Ar″ may be substituted by one or more groups, wherein the substitutions may be, for example, silyl groups, nitro groups, cyano groups, amine groups, hydroxy groups, alkoxy groups, aryloxy groups, alkylthio groups, arylthio groups, aldehyde groups, ketone groups, ester groups, amide groups, carboxylic acid groups, sulfonic acid groups, and mixtures thereof.

In embodiments, the charge transport compound is selected from the group consisting of:

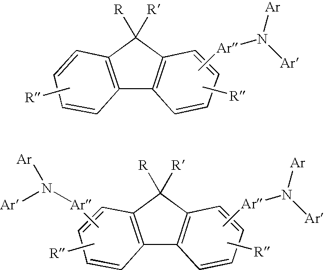

and mixtures thereof, wherein R and R′ are the same, and wherein R and R′ represent a cross-linking group or wherein R and R′ are ω-hydroxy-substituted alkyl groups having 1 to 8 carbon atoms or ω-hydroxy-substituted alkoxy groups having 1 to 8 carbon atoms, wherein R″ represents a hydrogen atom, wherein Ar represents a phenyl group, wherein Ar′ represents a 3-methylphenyl group, and Ar″ represents a chemical bond between the nitrogen atom and the fluorene moiety.

In embodiments, suitable examples of the charge transport compound include:

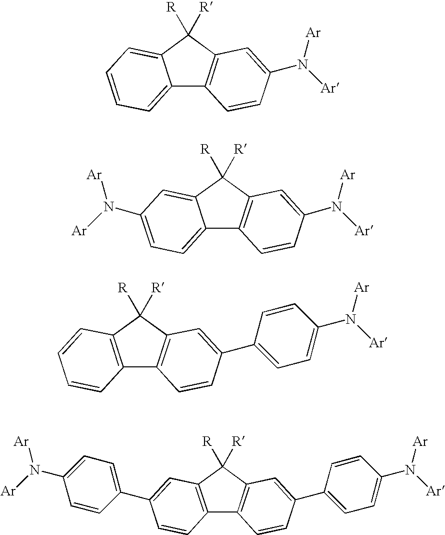

and mixtures thereof, wherein R and R″ may be the same or different, and are as described above, for example at least one of R or R′ is OH, a hydroxy-substituted alkyl group wherein the alkyl group may have from 1 to about 8 carbon atoms, a hydroxy-substituted alkoxyl group, wherein the alkoxyl group may have from 1 to about 8 carbon atoms, a hydroxy-substituted aryl group, a hydroxy-substituted aralkyl group, wherein the alkyl group and aryl group are as described above, and the like, and wherein Ar and Ar′ are the same or different, and are as described above. In embodiments, at least one of R and R′, including both, are a crosslinking group selected from the group consisting of ωhydroxy-substituted alkyl groups having 1 to 8 carbon atoms or ω-hydroxy-substituted alkoxy groups having 1 to 8 carbon atoms, Ar represents a phenyl group, and Ar′ represents a 3-methylphenyl group.

The fluorene-containing charge transport compounds described herein may be made by any suitable reaction scheme. The following two-step procedure for preparing the charge transport compound is representative:

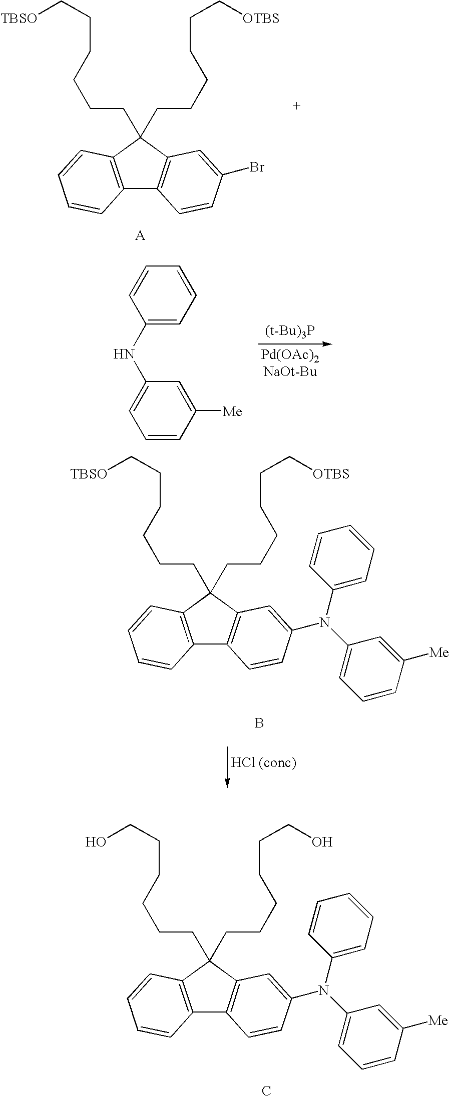

Compound A can be prepared by known procedures (see, for example, Hreha, R. D. et al., Tetrahedron 2004, 60, 7169). Step 1: A solution of Pd(OAc)₂ (52 mg, 3 mol %) and P(t-Bu)₃ (47 mg, 3 mol %) in toluene (25 mL) is prepared in a 100 mL container and the mixture was stirred under Ar for 10 min. Compound A (5.2 g, 7.7 mmol), 3-methyldiphenylamine (1.56 g, 8.5 mmol), and t-BuONa (1.48 g, 15.4 mmol) are added sequentially and the reaction is heated to 110° C. overnight (15 h) after which time HPLC shows no starting material remains. The reaction is cooled to room temperature and filtered through a Celite plug. Filtrol (8 g) and alumina (8 g) are added to the filtrate, which is heated to reflux for 1 h and filtered hot. HPLC of the filtrate shows no amine remains. The filtrate is concentrated to give a yellow oil. The compound is purified by chromatography to afford compound B as a yellow oil (3.45 g, 58%). Step 2: HCl (cone., 1 drop) is added to MeOH (5 mL) and this solution is added drop-wise to a solution of compound B (3.45 g, 4.44 mmol) in MeOH (25 mL) and tetrahydrofuran (THF) (5 mL). The reaction is stirred at room temperature and monitored by TLC (5% EtOAc in hexane). After 45 min, no starting material remains. The reaction is slowly poured into NaHCO₃ (sat. aq. 100 mL) and extracted with CH₂Cl₂ (3x). The organic extracts are dried (MgSO₄), filtered, and concentrated to afford compound C as a yellow oil. After purification by chromatography, compound C is obtained as a yellow oil (2.01 g, 83%).

The overcoat coating composition may contain from about 3 weight percent to about 80 weight percent of the charge transport compound, such as from about 10 weight percent to about 80 weight percent or from about 20 weight percent to about 60 weight percent, or from 30 weight percent to about 60 weight percent of the charge transport compound.

The overcoat coating composition may further include a curing agent. The curing agent may be, for example, a melamine-formaldehyde resin. The curing agent may assist in improving adhesion of the overcoat coating composition to the photoconductive imaging member. Other suitable curing agents may include benzoguanamine resins, such as alkoxymethyl derivatives of benzoguanamine resin, and cycloalkanediylbisguanamine resins and their derivatives. Molecular structures of suitable curing agents are:

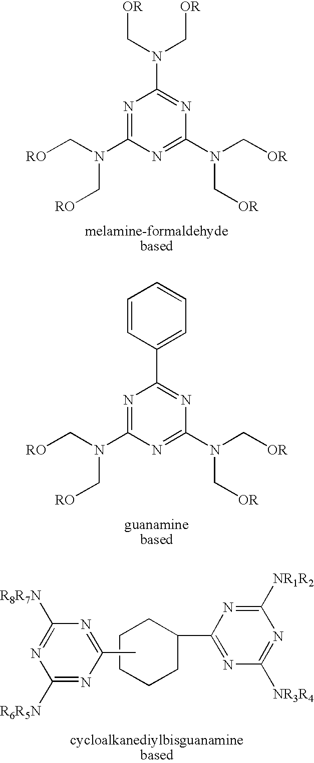

wherein R refers to an alkyl functional group that is linear, branched, saturated, unsaturated, substituted, or unsubstituted, and may have a carbon chain that may be, for example, from about 1 to about 32 carbon atoms in length and/or dimers, trimers, or oligomers of the parent compound. Additional curing agents may include epoxides and isocyanates.

In embodiments, an alkoxyl group represents an alkyl group linked to an oxygen molecule, and a cycloalkane group, also known as a naphthene group, represents molecules having one or more carbon rings to which hydrogen atoms are attached according to the formula CₙH₂ₙ. In embodiments, suitable melamine-formaldehyde resins may include, for example, CYMEL 1130, CYMEL 303 (both from Cytec) and/or mixtures thereof.

In embodiments, the curing agent may be present in the overcoat coating composition in amounts from about 1 weight percent to about 50 weight percent, such as from about 3 weight percent to about 40 weight percent or from about 5 weight percent to about 30 weight percent.

The components of the overcoat coating composition may be dispersed in a coating liquid. Examples of components that can be selected for use as coating liquids in the overcoat coating composition include ketones, alcohols, aromatic hydrocarbons, halogenated aliphatic hydrocarbons, ethers, amides, esters, and the like. Specific examples of coating liquids include cyclohexanone, acetone, methyl ethyl ketone, methanol, ethanol, 1-butanol, amyl alcohol, 1-methoxy-2-propanol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like.

Solvents suitable for use herein should not interfere with other components of the overcoat coating composition or the photoconductive member structure, and evaporate from the overcoat coating composition during curing. In embodiments, the solvent is present in the overcoat coating composition in an amount from about 20 weight percent to about 90 weight percent, such as from about 30 weight percent to about 85 weight percent or from about 40 weight percent to about 80 weight percent, of the overcoat coating composition.

In embodiments, the formulation of the overcoat coating composition may include an acid catalyst that may be dissolved in an alcohol solvent. The acid catalyst may initiate and/or accelerate the cross-linking reaction during coating. A suitable acid catalyst may include p-toluenesulfonic acid (p-TSA), and suitable alcohol solvents may include Dowanol, isopropanol and/or mixtures thereof. Other sulfonic acids or amine salt derivatives such as pyridine p-toluenesulfonate may also be used. The acid catalyst, when present, may be included in the composition in an amount of from more than 0% to about 5% by weight of the composition, such as from about 0.5 to about 2.5% by weight or from about 0.75 to about 1.25% by weight.

The overcoat coating composition may or may not further include optional components such as a polymer binder and a polymer co-binder. A polymer binder and/or co-binder may be employed to achieve improved coating and coating uniformity.

Different classes of binders that contain pendent functional groups capable of cross linking may be used as the binder and/or co-binder. For example, functionalized polycarbonates, polyesters, and polyacrylates may be suitable binders. Commercially available binders that meet these characteristics include the hydroxyalkyl functioned polyester DESMOPHEN-800 from Bayer, and the hydroxyalkyl functionalized polyacrylate JONCRYL 587, available from BASF. Other specific suitable polymer binders may include, but are not limited to, polypropylene glycols (such as, for example, PPG 2000), acrylic polyols (such as, for example, B-60 from OPC Polymers, JONCRYL 510 or JONCRYL 517 from Johnson Polymers), and the like.

The binder for the overcoat layer may include one or more of thermoplastic and thermosetting resins such as polyamide, polyurethane, polyvinyl acetate, polyvinyl butyral, polysiloxane, polyacrylate, polyvinyl acetal, phenylene oxide resins, terephthalic acid resins, phenoxy resin, epoxy resin, acrylonitrile copolymer, cellulosic film former, poly(amideimide) and the like. These polymers may block, random or alternating copolymers. The polymer binder such as polyvinylbutyral (PVB) may provide a desired rheology for coating, and may improve the coating quality of the overcoat film.

In embodiments, the binder may be a polyester polyol, such as a highly branched polyester polyol. By “highly branched” is meant a prepolymer synthesized using a significant amount of trifunctional alcohols, such as triols, to form a polymer having a significant number of branches off of the main polymer chain. This is distinguished from a linear prepolymer that contains only difunctional monomers, and thus little or no branches off of the main polymer chain. As used herein, “polyester polyol” is meant to encompass such compounds that include multiple ester groups as well as multiple alcohol (hydroxyl) groups in the molecule, and which can include other groups such as, for example, ether groups and the like. In embodiments, the polyester polyol can thus include ether groups, or can be free of ether groups.

It has been found that such polyester polyols provide improved results when incorporated as a binder in the overcoating layer, particularly when combined with the hole transporting molecule. Specifically, the polyester polyols provide hard binder layers, but which layers remain flexible and are not prone to crack formation.

Examples of such suitable polyester polyols include, for example, polyester polyols formed from the reaction of a polycarboxylic acid such as a dicarboxylic acid or a tricarboxylic acid (including acid anhydrides) with a polyol such as a diol or a triol. In embodiments, the number of ester and alcohol groups, and the relative amount and type of polyacid and polyol, can be selected such that the resulting polyester polyol compound retains a number of free hydroxyl groups, which can be used for subsequent crosslinking of the material in forming the overcoating layer binder material. For example, suitable polycarboxylic acids include adipic acid (COOH[CH₂]₄COOH), pimelic acid (COOH[CH₂]₅COOH), suberic acid (COOH[CH₂]₆COOH), azelaic acid (COOH[CH₂]₇COOH), sebacic acid (COOH[CH₂]COOH), and the like. Suitable polyols include, for example, difunctional materials such as glycols or trifunctional alcohols such as triols and the like, including propanediols (HO[CH₂]₃OH), butanediols (HO[CH₂]₄OH), hexanediols (HO[CH₂]₆OH), glycerine (HOCH₂CHOHCH₂OH), 1,2,6-hexanetriol (HOCH₂CHOH[CH₂]₄OH), and the like.

In embodiments, the suitable polyester polyols are reaction products of polycarboxylic acids and polyols and can be represented by the following formula (1): [CH₂RₐCH₂]ₘ[CO₂R_{b}CO₂]ₙ[CH₂R_{c}CH₂]ₚ[CO₂R_{d}CO₂]_{q} (1) where Ra and Rc independently represent linear alkyl groups or branched alkyl groups derived from the polyols, the alkyl groups having from 1 to about 20 carbon atoms; Rb and Rd independently represent alkyl groups derived from the polycarboxylic acids, the alkyl groups having from 1 to about 20 carbon atoms; and m, n, p, and q represent mole fractions of from 0 to 1, such that n+m+p+q=1.

Specific commercially available examples of such suitable polyester polyols include, for example: the DESMOPHEN® series of products available from Bayer Chemical, including the DESMOPHEN® 800, 1110, 1112, 1145, 1150, 1240, 1262, 1381, 1400,1470, 1630, 1652, 2060, 2061, 2062, 3060, 4027, 4028, 404, 4059, 5027, 5028, 5029, 5031, 5035, and 5036 products; the SOVERMOL® series of products available from Cognis, including the SOVERMOL®750, 805, 815, 908, 910, and 913 products; and the HYDAGEN® series of products available from Cognis, including the HYDAGEN® HSP product; and mixtures thereof. In embodiments, for example, are DESMOPHEN® 800 and SOVERMOL® 750, or mixtures thereof. DESMOPHEN® 800 is a highly branched polyester bearing hydroxyl groups, having an acid value of less than or equal to 4 mg KOH/g, a hydroxyl content of about 8.6+/−0.3%, and an equivalent weight of about 200. DESMOPHEN® 800 contains 50 parts adipic acid, 10 parts phthalic anhydride, and 40 parts 1,2,6-hexanetriol. DESMOPHEN® 1100 contains 60 parts adipic acid, 40 parts 1,2,6-hexanetriol, and 60 parts 1,4-butanediol. SOVERMOL® 750 is a branched polyether/polyester/polyol having an acid value of less than or equal to 2 mg KOH/g, and a hydroxyl value of 300-330 mg KOH/g.

Examples of the polyol used for obtaining a crystalline polyester include ethylene glycol, diethylene glycol, triethylene glycol, 1,2-propylene glycol, 1,3-propylene glycol, 1,4-butanediol, 1,4-butenediol, neopentyl glycol, 1,5-pentaneglycol, 1,6-hexaneglycol, 1,4-cyclohexanediol, 1,4-cyclohexanedimethanol, dipropylene glycol, polyethylene glycol, polypropylene glycol, polytetramethylene glycol, bisphenol A, bisphenol Z and hydrogenated bisphenol A.

Polyhydric alcohols used for obtaining an amorphous polyester may be, for example, an aliphatic, alicyclic or aromatic alcohol, and examples thereof include, but are not limited to, 1,5-pentanediol, 1,6-hexanediol, 1,4-cyclohexanediol, 1,4-cyclohexane-dimethanol, dipropylene glycol, polyethylene glycol, polypropylene glycol, polytetramethylene glycol, bisphenol A, bisphenol Z and hydrogenated bisphenol A.

Further polyols include compounds having no addition-polymerizable unsaturated group and having two or more hydroxyl groups within one molecule. Out of these compounds, the diol is a compound having two hydroxyl groups within one molecule, and examples thereof include ethylene glycol, propylene glycol, butanediol, diethylene glycol, hexanediol, cyclohexanediol, octanediol, decanediol and dodecanediol. Examples of the polyol other than the diol include glycerin, pentaerythritol, hexamethylolmelamine, hexaethylolmelamine, tetrametlylolbenzoguanamine and tetraethylolbenzoguanamine. One of these polyhydric alcohols may be used alone, or two or more thereof may be used in combination.

In other embodiments, the binder can include an acrylated polyol. Suitable acrylated polyols can be, for example, the reaction products of propylene oxide modified with ethylene oxide, glycols, triglycerol and the like.

In embodiments, suitable polymer co-binders may include any of the above binders in combination.

In embodiments, if present, the polymer binder and/or co-binder is present in the overcoat coating composition in an amount from about 1 weight percent to about 75 weight percent, such as from about 20 weight percent to about 60 weight percent or from about 1 weight percent to about 20 weight percent or such as from about 1 weight percent to about 15 weight percent, of the overcoat coating composition.

The overcoat coating composition may, in embodiments, include other optional additives, such as leveling agents such as silicon oil, metal oxides, surfactants, wear resistant additives such as polytetrafluoroethylene (PTFE) particles, light shock resisting or reducing agents, and the like.

In embodiments, the overcoat coating composition may be prepared by mixing the curing agent with the charge transport compound in an alcohol solution and an acid catalyst. Mixing may be effected in any order and under any suitable conditions. In embodiments, optional components may be mixed into the overcoat coating composition.

The overcoat coating composition may be applied by any suitable application technique, such as spraying, dip coating, roll coating, wire wound rod coating, and the like. In embodiments, the overcoat coating composition may be coated onto any layer of the photoconductive imaging member, such as the charge transport layer, the charge generating layer, a combination charge transport/charge generating layer, or the like.

After the overcoat coating composition is coated onto the photoconductive member, the coating composition can be cured at a temperature from about 50° C. to about 250° C., such as from about 80° C. to about 200° C. or from about 100° C. to about 175° C. The deposited overcoat layer may be cured by any suitable technique, such as oven drying, infrared radiation drying, and the like.

The curing may take from about 1 minute to about 90 minutes, such as from about 3 minutes to about 75 minutes or from about 5 minutes to about 60 minutes. The curing reaction substantially forms a crosslinked structure, which may be confirmed when the overcoat layer does not dissolve in part or in its entirety when contacted with organic solvents. Thus, organic solvents may be used to confirm the formation of a crosslinked or substantially crosslinked product. If a substantially crosslinked product is formed, the organic solvent will not usually dissolve any component of the overcoat layer. Such suitable organic solvents may include an alkyl halides, like methylene chloride; alcohols, like methanol, ethanol, and the like; ketones, like acetone, and the like. Any suitable organic solvent, and mixtures thereof, may be employed to confirm the formation of a substantially crosslinked overcoat layer if desired.

The overcoat layer described herein may be continuous and may have a thickness of less than about 75 micrometers, for example from about 0.1 micrometers to about 60 micrometers, such as from about 0.1 micrometers to about 50 micrometers or from about 1 to about 25 micrometers.

The overcoat layer disclosed herein in embodiments can achieve excellent adhesion to the charge transport layer or other adjacent layers of the photoconductive imaging member without substantially negatively affecting the electrical performance of the imaging member to an unacceptable degree.

The photoconductive members are, in embodiments, multilayered photoreceptors that comprise, for example, a substrate, an optional conductive layer, an optional undercoat layer, an optional adhesive layer, a charge generating layer, a charge transport layer, and the above-described overcoat layer. The photoconductive member may have any suitable form, for example plate, endless belt or drum form.

Illustrative examples of substrate layers selected for the photoconductive imaging members, and which substrates may be known substrates and which can be opaque or substantially transparent, comprise a layer of insulating material including inorganic or organic polymeric materials, such as MYLAR®, a commercially available polymer, a metalized polymer, MYLAR® containing titanium, a layer of an organic or inorganic material having a semiconductive surface layer, such as indium tin oxide, or aluminum arranged thereon, or a conductive material inclusive of aluminum, chromium, nickel, brass or the like. The substrate may be flexible, seamless, or rigid, and may have a number of many different configurations, such as, a plate, a cylindrical drum, a scroll, an endless flexible belt, and the like. In one embodiment, the substrate is in the form of a seamless flexible belt. In some situations, it may be desirable to coat on the back of the substrate, particularly when the substrate is a flexible organic polymeric material, an anticurl layer, such as polycarbonate materials commercially available as MAKROLON®.

The thickness of the substrate layer depends on a number of factors, including the characteristics desired and economical considerations, thus this layer may be a thickness of about 50 microns to about 7,000 microns, such as from about 50 microns to about 3,000 microns or from about 75 microns to about 3000 microns.

If a conductive layer is used, it is positioned over the substrate. The term “over” as used herein in connection with many different types of layers, as well as the term “under,” should be understood as not being limited to instances where the specified layers are contiguous. Rather, the term refers to relative placement of the layers and encompasses the inclusion of unspecified intermediate layers between the specified layers.

Suitable materials for the conductive layer include aluminum, zirconium, niobium, tantalum, vanadium, haffnium, titanium, nickel, stainless steel, chromium, tungsten, molybdenum, copper, and the like, and mixtures and alloys thereof.

The thickness of the conductive layer is, in an embodiment, from about 20 angstroms to about 750 angstroms, such as from about 35 angstroms to about 500 angstroms or from about 50 angstroms to about 200 angstroms, for a suitable combination of electrical conductivity, flexibility, and light transmission. However, the conductive layer can, if desired, be opaque.

The conductive layer can be applied by known coating techniques, such as solution coating, vapor deposition, and sputtering. In embodiments, an electrically conductive layer is applied by vacuum deposition. Other suitable methods can also be used.

If an undercoat layer is employed, it may be positioned over the substrate, but under the charge generating layer. The undercoat layer is at times referred to as a hole-blocking layer in the art.

Suitable undercoat layers for use herein include polymers, such as polyvinyl butyral, epoxy resins, polyesters, polysiloxanes, polyamides, polyurethanes, and the like, nitrogen-containing siloxanes or nitrogen-containing titanium compounds, such as trimethoxysilyl propyl ethylene diamine, N-beta (aminoethyl) gamma-aminopropyl trimethoxy silane, isopropyl 4-aminobenzene sulfonyl titanate, di(dodecylbenezene sulfonyl) titanate, isopropyl di(4-aminobenzoyl) isostearoyl titanate, isopropyl tri(N-ethyl amino) titanate, isopropyl trianthranil titanate, isopropyl tri(N,N-dimethyl-ethyl amino) titanate, titanium-4-amino benzene sulfonate oxyacetate, titanium 4-aminobenzoate isostearate oxyacetate, gamma-aminobutyl methyl dimethoxy silane, gamma-aminopropyl methyl dimethoxy silane, gamma-aminopropyl trimethoxy silane and/or mixtures thereof.

The undercoat layer may be applied as a coating by any suitable conventional technique such as spraying, die coating, dip coating, draw bar coating, gravure coating, silk screening, air knife coating, reverse roll coating, vacuum deposition, chemical treatment and the like. For convenience in obtaining layers, the undercoat layers may be applied in the form of a dilute solution, with the solvent being removed after deposition of the coating by conventional teclniques such as by vacuum, heating and the like. Drying of the deposited coating may be achieved by any suitable technique such as oven drying, infrared radiation drying, air drying and the like.

In fabricating a photoconductive imaging member, a charge generating layer is deposited and a charge transport layer may be deposited onto the substrate surface either in a laminate type configuration where the charge generating layer and charge transport layer are in different layers or in a single layer configuration where the charge generating layer and charge transport layer are in the same layer along with a binder resin. In embodiments, the charge generating layer is applied prior to the charge transport layer.

The charge generating layer is positioned over the undercoat layer. If an undercoat layer is not used, the charge generating layer is positioned over the substrate. In embodiments, the charge generating layer is comprised of amorphous films of selenium and alloys of selenium and arsenic, tellurium, germanium and the like, hydrogenated amorphous silicon and compounds of silicon and germanium, carbon, oxygen, nitrogen and the like fabricated by vacuum evaporation or deposition. The charge generating layers may also comprise inorganic pigments of crystalline selenium and its alloys; Group II-VI compounds; and organic pigments such as quinacridones, polycyclic pigments such as dibromo anthanthrone pigments, perylene and perinone diamines, polynuclear aromatic quinones, azo pigments including bis-, tris- and tetrakis-azos; and the like dispersed in a film forming polymeric binder and fabricated by solvent coating techniques.

Phthalocyanines have been employed as photogenerating materials for use in laser printers using infrared exposure systems. Infrared sensitivity is desired for photoreceptors exposed to low-cost semiconductor laser diode light exposure devices. The absorption spectrum and photosensitivity of the phthalocyanines depend on the central metal atom of the compound. Many metal phthalocyanines have been reported and include, oxyvanadium phthalocyanine, chloroaluminum phthalocyanine, copper phthalocyanine, oxytitanium phthalocyanine, chlorogallium phthalocyanine, hydroxygallium phthalocyanine magnesium phthalocyanine and metal-free phthalocyanine. The phthalocyanines exist in many crystal forms, and have a strong influence on photogeneration.

Any suitable polymeric film-forming binder material may be employed as the matrix in the charge generating (photogenerating) binder layer. Typical organic polymeric film forming binders may include thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazole, and the like. These polymers may be block, random or alternating copolymers.

A photogenerating composition or pigment may be present in the resinous binder composition in various amounts. Generally, however, from about 5 percent by volume to about 90 percent by volume of the photogenerating pigment is dispersed in about 10 percent by volume to about 95 percent by volume of the resinous binder, and typically from about 20 percent by volume to about 30 percent by volume of the photogenerating pigment is dispersed in about 70 percent by volume to about 80 percent by volume of the resinous binder composition. The photogenerator layers can also fabricated by vacuum sublimation in which case there is no binder.

In embodiments, any suitable technique may be used to mix and thereafter apply the photogenerating layer coating mixture. Typical application techniques include spraying, dip coating, roll coating, wire wound rod coating, vacuum sublimation and the like. For some applications, the charge generating layer may be fabricated in a dot or line pattern. Removing of the solvent of a solvent coated layer may be effected by any suitable technique such as oven drying, infrared radiation drying, air drying and the like. In embodiments, the charge generating layer is from about 0.1 micrometers to about 100 micrometers thick, such as from about 0.1 micrometers to about 75 micrometers or from about 0.1 micrometers to about 50 micrometers.

In embodiments, a charce transport layer may be employed. The charge transport layer may comprise a charge-transporting molecule, such as, a small molecule, for example, a tertiary arylamine, dissolved or molecularly dispersed in a film forming electrically inert polymer such as a polycarbonate. The expression charge transporting “small molecule” refers to, for example, a monomer that allows the free charge photogenerated in the generator layer to be transported across the transport layer. In embodiments, the term “dissolved” refers to, for example, forming a solution in which the molecules are distributed in the polymer to form a homogeneous phase. In embodiments, the expression “molecularly dispersed” refers to a dispersion in which a charge transporting small molecule dispersed in the polymer, for example on a molecular scale.

Any suitable charge transporting or electrically active small molecule may be employed in the charge transport layer. The charge transporting molecule in the charge transport layer may be different than the charge transporting compound in the overcoat coating.

Typical charge transporting molecules include, for example, pyrene, carbazole, hydrazone, oxazole, oxadiazole, pyrazoline, arylamine, arylmethane, benzidine, thiazole, stilbene and butadiene compounds; pyrazolines such as 1-phenyl-3-(4′-diethylaminostyryl)-5-(4′-diethylamino phenyl)pyrazoline; diamines such as N,N′-diphenyl-N,N′-bis(3-methylphenyl)-(1,1′-biphenyl)-4,4′-diamine; hydrazones such as N-phenyl-N-methyl-3-(9-ethyl)carbazyl hydrazone and 4-diethyl amino benzaldehyde-1,2-diphenyl hydrazone; oxadiazoles such as 2,5-bis (4-N,N′-diethylaminophenyl)-1,2,4-oxadiazole; poly-N-vinylcarbazole, poly-N-vinylcarbazole halide, polyvinyl pyrene, polyvinylanthracene, polyvinylacridine, a pyrene-formaldehyde resin, an ethylcarbazole-formaldehyde resin, a triphenylmethane polymer and polysilane, and the like.

In embodiments, to minimize or avoid cycle-up in machines with high throughput, the charge transport layer may be substantially free (such as, from zero to less than about two percent by weight of the charge transport layer) of triphenylmethane. As indicated above, suitable electrically active small molecule charge transporting compounds are dissolved or molecularly dispersed in electrically inactive polymeric film forming materials.

An exemplary small molecule charge transporting compound that permits injection of holes from the pigment into the charge generating layer with high efficiency and transports them across the charge transport layer with very short transit times is N,N′-diphenyl-N,N′-bis(3-methylphenyl)-(1,1′-biphenyl)-4,4′-diamine. If desired, the charge transport material in the charge transport layer may comprise a polymeric charge transport material or a combination of a small molecule charge transport material and a polymeric charge transport material.

In embodiments, the charge transport layer may contain an active aromatic diamine molecule, which enables charge transport, dissolved or molecularly dispersed in a film forming binder. An exemplary charge transport layer may consist of a polycarbonate resinous material having dispersed therein from about 25 to about 75 percent by weight of the diamines. In other embodiments, the charge transport layer may comprise a transparent electrically inactive polycarbonate resin having one or more dissolved diamines.

Any suitable electrically inactive resin binder that is ideally substantially insoluble in the solvent such as alcoholic solvent used to apply the optional overcoat layer may be employed in the charge transport layer. Typical inactive resin binders include polycarbonate resin, polyester, polyarylate, polyacrylate, polyether, polysulfone, and the like. Molecular weights can vary, such as from about 20,000 to about 150,000. Exemplary binders include polycarbonates such as poly (4,4′-isopropylidene-diphenylene)carbonate (also referred to as bisphenol-A-polycarbonate); polycarbonate, poly (4,4′-cyclohexylidinediphenylene) carbonate (referred to as bisphenol-Z polycarbonate), poly (4,4′-isopropylidene-3,3′-dimethyl-diphenyl)carbonate (also referred to as bisphenol-C-polycarbonate), and the like.

Any suitable charge transporting polymer may also be utilized in the charge transporting layer of this disclosure. The charge transporting polymer should be insoluble in the solvent employed to apply the overcoat layer. These electrically active charge transporting polymeric materials should be capable of supporting the injection of photogenerated holes from the charge generating material and be capable of allowing the transport of these holes therethrough.

Any suitable technique may be utilized to mix and thereafter apply the charge transport layer coating mixture to the charge generating layer. Typical application techniques include spraying, dip coating, roll coating, wire wound rod coating, and the like. Drying of the deposited coating may be effected by any suitable technique such as oven drying, infrared radiation drying, air drying and the like.

Generally, the thickness of the charge transport layer is from about 10 to about 100 micrometers, but a thickness outside this range can also be used. A charge transport layer should be an insulator to the extent that the electrostatic charge placed on the charge transport layer is not conducted in the absence of illumination at a rate sufficient to prevent formation and retention of an electrostatic latent image thereon. In general, the ratio of the thickness of a charge transport layer to the charge generating layers may be maintained from about 2:1 to 200:1, and in some instances as great as 400:1. Typically, a charge transport layer is substantially non-absorbing to visible light or radiation in the region of intended use but is electrically “active” in that it allows the injection of photogenerated holes from the photoconductive layer, that is, charge generation layer, and allows these holes to be transported through itself to selectively discharge a surface charge on the surface of the active layer.

Additionally, adhesive layers can be provided, if necessary or desired, between any of the layers in the photoreceptors to ensure adhesion of any adjacent layers. Alternatively, or in addition, adhesive material can be incorporated into one or both of the respective layers to be adhered. Such optional adhesive layers may have a thickness of about 0.001 micrometer to about 0.2 micrometer. Such an adhesive layer can be applied, for example, by dissolving adhesive material in an appropriate solvent, applying by hand, spraying, dip coating, draw bar coating gravure coating, silk screening, air knife coating, vacuum deposition, chemical treatment, roll coating, wire wound rod coating, and the like, and drying to remove the solvent. Suitable adhesives include film-forming polymers, such as polyester, DuPont 49,000 (available from E. I. DuPont de Nemours & Co.), VITEL PE-100 (available from Goodyear Tire and Rubber Co.), polyvinyl butyral, polyvinyl pyrrolidone, polyurethane, polymethyl methacrylate, and the like.

Optionally, an anti-curl backing layer may be employed to balance the total forces of the layer or layers on the opposite side of the supporting substrate layer. An example of an anti-curl backing layer may include a film forming binder, crystalline particles dispersed in the film forming binder and a reaction product of a bifunctional chemical coupling agent with both the film forming binder and the crystalline particles. A thickness from about 70 to about 160 micrometers may be a satisfactory range for flexible photoreceptors.

Processes of imaging, especially xerographic imaging, and printing, including digital, are also encompassed herein. More specifically, the photoconductive imaging members can be selected for a number of different known imaging and printing processes including, for example, electrophotographic imaging processes, especially xerographic imaging and printing processes wherein charged latent images are rendered visible with toner compositions of an appropriate charge polarity. Moreover, the imaging members of this disclosure are useful in color xerographic applications, particularly high-speed color copying and printing processes.

Also included in the present disclosure are methods of imaging and printing with the photoconductive devices illustrated herein. These methods generally involve the formation of an electrostatic latent image on the imaging member, followed by developing the image with a toner composition comprised, for example, of thermoplastic resin, colorant, such as pigment, charge additive, and surface additives, reference U.S. Pat. Nos. 4,560,635; 4,298,697 and 4,338,390, the disclosures of which are totally incorporated herein by reference, subsequently transferring the image to a suitable substrate, and permanently affixing the image thereto.

The following Examples are submitted to illustrate embodiments of the present disclosure.

An overcoat formulation was prepared as follows: a mixture of a polyacrylate polyol binder (1 part), a charge transport compound containing a fluorene moiety with two cross-linking substituents at the 9-position, 2-[N-phenyl-N-(3-methylphenyl)amine]-9,9-bis-(6-hydroxyhexyl)-fluorene (2.05 parts), and a melamine-formaldehyde resin cross-linking agent (1.4 parts) was dissolved in a solvent of 1-methoxy-2-propanol (13.6 parts). Prior to coating (less than 45 min) a p-toluenesulfonic acid amine salt promoter (0.1 parts) and a leveling agent (0.04 parts) were added and the solution was applied onto the photoreceptor surface and more specifically onto the charge transport layer, using cup coating technique, followed by thermal curing at 140° C. for 40 minutes to form an overcoat layer having a film thickness of 3 μm. The resulting overcoat layer contained about 35 to 45 weight percent of the charge transport compound.

A Comparative Example photoreceptor or photoconductor was prepared by repeating the above process except that the charge transport compound was N,N′-bis(3-hydroxyphenyl)-N,N′-diphenyl-1,1′-biphenyl-4,4′-diamine.

Evaluation of Photoreceptor Performance:

The electrical performance characteristics of the above prepared photoreceptors such as electrophotographic sensitivity and short term cycling stability were tested in a scanner. The scanner is equipped with means to rotate the drum while it is electrically charged and discharged. The charge on the photoconductor sample is monitored through use of electrostatic probes placed at precise positions around the circumference of the device. The photoreceptor devices are charged to a negative potential of 700 Volts. As the devices rotate, the initial charging potentials are measured by a first voltage probe. The photoconductor samples are then exposed to monochromatic radiation of known intensity, and the surface potential measured by second and third voltage probes. Finally, the samples are exposed to an erase lamp of appropriate intensity and wavelength and any residual potential is measure by a fourth voltage probe. The process is repeated under the control of the scanner's computer, and the data is stored in the computer. The PIDC (photo induced discharge curve) is obtained by plotting the potentials at the second and third voltage probes as a function of the light energy. The example photoreceptor having the overcoat layer showed comparable PIDC characteristics as the Comparative Example device.

The electrical cycling performance of the photoreceptor was performed using an in-house fixture similar to a xerographic system. The example photoreceptor device with the overcoat showed stable cycling of over 170,000 cycles in a humid environment (28° C., 80% RH).

The wear resistance for the above photoconductors was measured using an in-house testing fixture comprising a BCR (bias-charging roller) charging unit, an exposure unit, a toner developer unit, and a cleaning unit. The photoreceptor drum was set to rotate at about 88 RPM for 50,000 cycles. The thickness of the photoreceptor was measured at the beginning and at the end of the testing. The wear rate was estimated based on the thickness loss and was expressed in nanometer per kilocycle. The example photoreceptor with the overcoat offers a wear rate of about 40.2 nm/kc, as compared to the wear rate of about 85 nm/kc for the comparative examle photoreceptor.

It will be appreciated that various of the above-disclosed and other features and functions, or alternatives thereof, may be desirably combined into many other different systems or applications. Also, it will be appreciated that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A photoconductive member comprising:
a layer comprising a substantially crosslinked product of a film-forming composition comprising at least a curing agent and a charge transport compound, wherein the charge transport compound has at least one group imparting charge transporting functionality, at least one crosslinking group and at least one fluorene moiety.

2. The photoconductive member according to claim 1, wherein the at least one crosslinking group is selected from the group consisting of OH, hydroxy-substituted alkyl groups wherein the alkyl group has from 1 to about 32 carbon atoms, hydroxy-substituted alkoxyl groups wherein the alkoxyl group has from 1 to about 32 carbon atoms, a hydroxy-substituted aryl group, and a hydroxy-substituted aralkyl group.

3. The photoconductive member according to claim 1, wherein the at least one crosslinking group is located at the 9-position of the fluorene moiety.

4. The photoconductive member according to claim 3, wherein the at least one crosslinking group is selected from the group consisting of OH, hydroxy-substituted alkyl groups wherein the alkyl group has from 1 to about 8 carbon atoms, hydroxy-substituted alkoxyl groups wherein the alkoxyl group has from 1 to about 8 carbon atoms, a hydroxy-substituted aryl group, and a hydroxy-substituted aralkyl group.

5. The photoconductive member according to claim 1, wherein the at least one group imparting charge transporting functionality is an arylamine.

6. The photoconductive member according to claim 1, wherein the curing agent is a melamine-formaldehyde resin, benzoguanamine resin, cycloalkanediylbisguanamine resin, epoxide, isocyanate or derivatives thereof.

7. The photoconductive member according to claim 1, wherein the layer further comprises a polymer binder selected from the group consisting of a polyester polyol, an acrylic polyol and mixtures thereof.

8. The photoconductive member according to claim 1, wherein the charge transport compound is selected from the group consisting of: 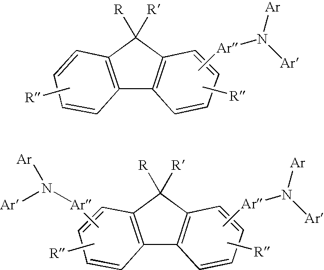
and mixtures thereof, wherein R, R′ and R″ may be the same or different, and wherein at least one of R, R′ and R″ represents a crosslinking group selected from the group consisting of OH, hydroxy-substituted alkyl groups wherein the alkyl group has from 1 to about 32 carbon atoms, hydroxy-substituted alkoxyl groups wherein the alkoxyl group has from 1 to about 32 carbon atoms, a hydroxy-substituted aryl group, and a hydroxy-substituted aralkyl group, wherein Ar, Ar′ and Ar″ each independently represents an aryl group, or wherein Ar″ independently represents a chemical bond between the nitrogen atom and the fluorene moiety, or an arylene group.

9. The photoconductive member according to claim 1, wherein the charge transport compound is selected from the group consisting of: 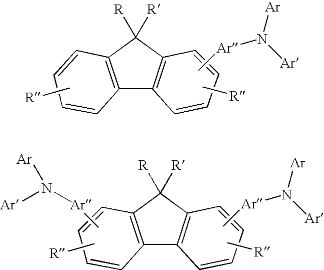
and mixtures thereof, wherein R and R′ are the same and represent a crosslinking group selected from the group consisting of ω-hydroxy-substituted alkyl groups having 1 to 8 carbon atoms and ω-hydroxy-substituted alkoxy groups having 1 to 8 carbon atoms, wherein R″ represents a hydrogen atom, wherein Ar represents a phenyl group, wherein Ar′ represents a 3-methylphenyl group, and Ar″ represents a chemical bond between the nitrogen atom and the fluorene moiety.

10. The photoconductive member according to claim 1, wherein the charge transport compound is selected from the group consisting of: 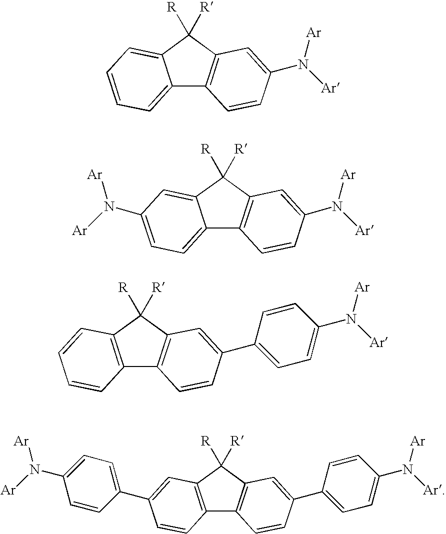
and mixtures thereof, wherein at least one of R and R′ is a crosslinking group selected from the group consisting of OH, a hydroxy-substituted alkyl group wherein the alkyl group has from 1 to about 8 carbon atoms, a hydroxy-substituted alkoxyl group wherein the alkoxyl group has from 1 to about 8 carbon atoms, a hydroxy-substituted aryl group, and a hydroxy-substituted aralkyl group, and wherein Ar and Ar′ each independently represents an aryl group.

11. The photoconductive member according to claim 1, wherein the charge transport compound is selected from the group consisting of: 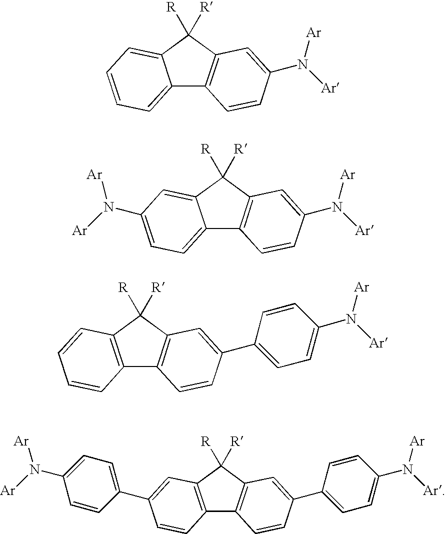
and mixtures thereof, wherein at least one of R and R′ represents a crosslinking group selected from the group consisting of ω-hydroxy-substituted alkyl groups having 1 to 8 carbon atoms and ω-hydroxy-substituted alkoxy groups having 1 to 8 carbon atoms, wherein Ar represents a phenyl group, and wherein Ar′ represents a 3-methylphenyl group.

12. A photoconductive member comprising:
a conductive substrate,
a charge generating layer,
a charge transport layer, and
an overcoat layer comprising a substantially crosslinked product of a film-forming composition comprising at least a curing agent and a charge transport compound, wherein the charge transport compound has at least one group imparting charge transporting functionality, at least one crosslinking group and at least one fluorene moiety.

13. The photoconductive member according to claim 12, wherein the at least one crosslinking group is selected from the group consisting of OH, hydroxy-substituted alkyl groups wherein the alkyl group has from 1 to about 32 carbon atoms, hydroxy-substituted alkoxyl groups wherein the alkoxyl group has from 1 to about 32 carbon atoms, a hydroxy-substituted aryl group, and a hydroxy-substituted aralkyl group.

14. The photoconductive member according to claim 12, wherein the at least one crosslinking group is located at the 9-position of the fluorene moiety.

15. The photoconductive member according to claim 14, wherein the at least one crosslinking group is selected from the group consisting of OH, hydroxy-substituted alkyl groups wherein the alkyl group has from 1 to about 8 carbon atoms, hydroxy-substituted alkoxyl groups wherein the alkoxyl group has from 1 to about 8 carbon atoms, a hydroxy-substituted aryl group, and a hydroxy-substituted aralkyl group.

16. The photoconductive member according to claim 12, wherein the at least one group imparting charge transporting functionality is an arylamine.

17. The photoconductive member according to claim 12, wherein the curing agent is a melamine-formaldehyde resin, benzoguanamine resin, cycloalkanediylbisguanamine resin, epoxide, isocyanate or derivatives thereof.

18. The photoconductive member according to claim 12, wherein the overcoat layer further comprises a polymer binder selected from the group consisting of a polyester polyol, an acrylic polyol and mixtures thereof.

19. The photoconductive member according to claim 12, wherein the charge transport compound is selected from the group consisting of: 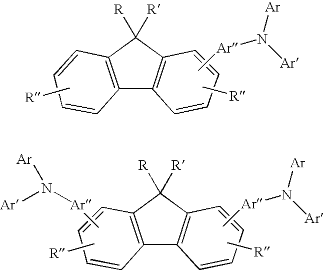
and mixtures thereof, wherein R, R′ and R″ may be the same or different, and wherein at least one of R, R′ and R″ represents a crosslinking group selected from the group consisting of OH, hydroxy-substituted alkyl groups wherein the alkyl group has from 1 to about 32 carbon atoms, hydroxy-substituted alkoxyl groups wherein the alkoxyl group has from 1 to about 32 carbon atoms, a hydroxy-substituted aryl group, and a hydroxy-substituted aralkyl group, wherein Ar, Ar′ and Ar″ each independently represents an aryl group, or wherein Ar″ independently represents a chemical bond between the nitrogen atom and the fluorene moiety, or an arylene group.

20. The photoconductive member according to claim 12, wherein the charge transport compound is selected from the group consisting of: 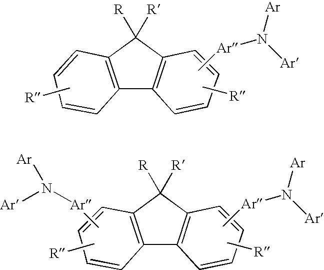
and mixtures thereof, wherein R and R′ are the same and represent a crosslinking group selected from the group consisting of ω-hydroxy-substituted alkyl groups having 1 to 8 carbon atoms and ω-hydroxy-substituted alkoxy groups having 1 to 8 carbon atoms, wherein R″ represents a hydrogen atom, wherein Ar represents a phenyl group, wherein Ar′ represents a 3-methylphenyl group, and Ar″ represents a chemical bond between the nitrogen atom and the fluorene moiety.

21. The photoconductive member according to claim 12, wherein the charge transport compound is selected from the group consisting of: 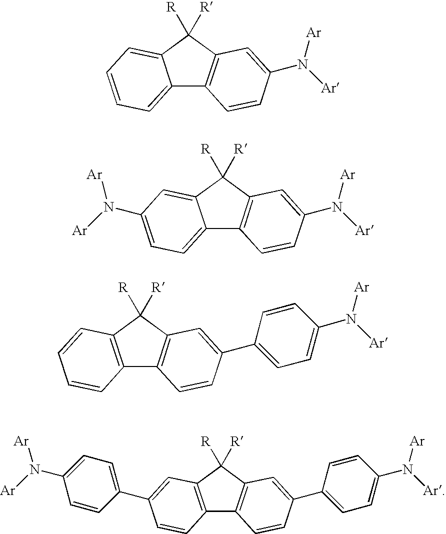
and mixtures thereof, wherein at least one of R and R′ is a crosslinking group selected from the group consisting of OH, a hydroxy-substituted alkyl group wherein the alkyl group has from 1 to about 8 carbon atoms, a hydroxy-substituted alkoxyl group wherein the alkoxyl group has from 1 to about 8 carbon atoms, a hydroxy-substituted aryl group, and a hydroxy-substituted aralkyl group, and wherein Ar and Ar′ each independently represents an aryl group.

22. The photoconductive member according to claim 12, wherein the charge transport compound is selected from the group consisting of: 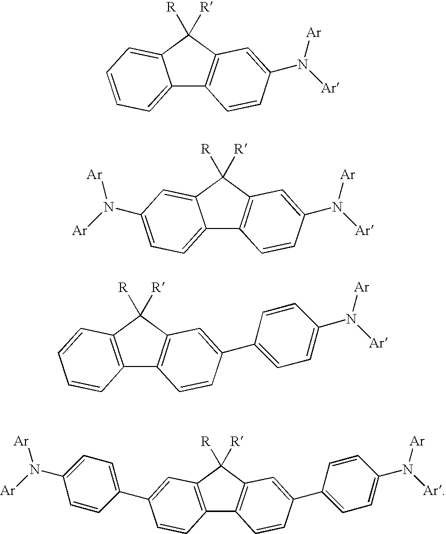
and mixtures thereof, wherein at least one of R and R′ represents a crosslinking group selected from the group consisting of ω-hydroxy-substituted alkyl groups having 1 to 8 carbon atoms and ω-hydroxy-substituted alkoxy groups having 1 to 8 carbon atoms, wherein Ar represents a phenyl group, and wherein Ar′ represents a 3-methylphenyl group.

23. The photoconductive member according to claim 12, wherein the charge generating layer and the charge transport layer are contained in a single layer, and wherein the layer is an overcoat layer in contact with the single layer.

24. The photoconductive member according to claim 12, wherein the substrate is aluminum or a metallized polymer, the charge generating layer is comprised of a phthalocyanine pigment-dispersed polymer, the charge transport layer is comprised of a tertiary arylamine blended into a polymer, and the overcoat layer has a layer thickness of from about 1 to about 6 microns.

25. An image forming apparatus comprising:
at least one charging unit,
at least one exposing unit,
at least one developing unit,
a transfer unit,
a cleaning unit, and
a photoconductive member that is in association with each unit or passes by each unit, comprising a layer comprising a substantially crosslinked product of a film-forming composition comprising at least a curing agent and a charge transport compound, wherein the charge transport compound has at least one group imparting charge transporting functionality, at least one crosslinking group and at least one fluorene moiety.
